(19) United States
(12) Patent Application Publication
(10) Pub. No.: US 2003/0076818 A1
(43) Pub. Date: Apr. 24, 2003

(54) Quality evaluation equipment of network speaking

(76) Inventors: Yoshihiro Miwa, Aichi-ken (JP); Koji Ohbayashi, Chiba-ken (JP); Kazuhiro Kashiwagi, Tokyo (JP)

Correspondence Address: LEWIS F. GOULD, JR., DUANE MORRIS LLP, ONE LIBERTY PLACE, PHILADELPHIA, PA, 19103, US

(21) Appl. No.: 10/278,136

(22) Filed: Oct. 21, 2002

(30) Foreign Application Priority Data
Oct. 24, 2001 (JP) 2001-326059

(51) Int. Cl. H04L 12/66

(52) U.S. Cl. 370/352

(57) ABSTRACT

In a network speaking for speaking with voice by exchanging voice packets 6 between a plurality of speaking terminals 3 connected with a communication network 2, a speaking quality monitoring unit 5 capable of computing speaking quality evaluation data is provided between the communication network and the speaking terminal, and the network speaking control unit 16 is provided with network speaking quality judging means 20, 22 for collecting speaking quality evaluation data computed by a plurality of the speaking quality monitoring units and computing and judging speaking quality of the communication network. The quality of the voice speaking exchanged between the speaking terminals can be judged without delay.

### BACKGROUND OF THE INVENTION

This invention relates to quality evaluation equipment of network speaking to be used for evaluating speaking quality in voice speaking, making use of a dedicated or a public packet data communication network and using data communication method, such as the internet protocol.

A recent trial is to speak with voice, making use of a communication network, such as the internet and a dedicated communication network, and it is practically used in a part. In the communication network, such as the internet, communication data are transferred, dividing into packets. When this is applied to voice speaking, but, voice quality (tone) declines by the delay, jitter (fluctuation of reaching time) or disappearing in the middle of transfer concerning the packet.

Then, various units for objectively evaluating such voice quality with numeric value or various appliances for judging as to which appliance on a network makes tone bad have been developed and sold at a market. But, all of such appliances is for evaluating the voice quality concerning a specific speaking terminal, and the appliance capable of judging the state of the quality of a lot of voice speaking exchanged between many speaking terminals at some point of time does not exist. Such an equipment is extremely important for a person of communication business or a manager of self-managing network who provide voice speaking service making use of such a communication network in analyzing and judging the quality of the service to be provided by one's own, and its development has been expected.

### SUMMARY OF THE INVENTION

The present invention is quality evaluation equipment of network speaking for speaking with voice by exchanging voice packets between a plurality of speaking terminals connected with a communication network through said communication network; said equipment comprising:

a speaking quality monitoring unit provided between said communication network and said speaking terminal, capable of obtaining speaking quality evaluation data (raw data, such as speaking quality evaluation value, delay of reaching of voice packet, jitter, disappearing of voice packet, reciprocating delay time, objective tone evaluation value or speaking quality data respectively computed therefrom) concerning a voice speaking through said communication network by said speaking terminal;

a network speaking control unit provided on said communication network; and

a network speaking quality judging means provided at said network speaking control unit, for collecting said speaking quality evaluation data computed by a plurality of said speaking quality monitoring units and computing and judging speaking quality of said communication network from said speaking quality evaluation data collected.

According to this, the speaking quality monitoring unit provided between the communication network and the speaking terminal obtains speaking quality evaluation data (raw data, such as speaking quality evaluation value, delay of reaching of voice packet, jitter, disappearing of voice packet, reciprocating delay time, objective tone evaluation value) by the speaking terminal through the communication network, and the network speaking quality judging means of the network speaking control unit collects speaking quality evaluation data computed by a plurality of the speaking quality monitoring units so as to compute and judge the speaking quality of the communication network from the speaking quality evaluation data collected. Then, the state of the quality of a lot of voice speaking exchanged between many speaking terminals on the packet communication network at some point of time can be judged without delay.

Besides, the present invention is the quality evaluation equipment of network speaking, wherein said speaking quality evaluation data include at least one data of data of jitter, disappearing, delay, reciprocating delay time, objective tone evaluation value concerning said voice packet obtained by each speaking quality monitoring unit.

According to this, the speaking quality evaluation data include at least one data of data concerning jitter, disappearing, delay, reciprocating delay time, objective tone evaluation value concerning voice packet greatly influencing speaking quality, thereby the speaking quality of the communication network can be properly judged.

Besides, the present invention is the quality evaluation equipment of network speaking, wherein said speaking quality monitoring unit comprises a speaking quality evaluation value computing means for judging speaking quality at the time of speaking from said speaking quality evaluation data obtained by said speaking quality monitoring unit and computing as speaking quality evaluation value, and a display means for displaying said speaking quality evaluation value judged by said speaking quality evaluation computing means.

According to this, the speaking quality at the time of speaking is judged from the speaking quality evaluation data on the speaking quality monitoring unit side and the speaking quality evaluation value is computed so as to display on the display means, thereby the state of the present speaking quality can be recognized on the speaking terminal side.

Besides, the present invention is the quality evaluation equipment of network speaking, wherein said network speaking quality judging means can compute and judge said speaking quality of said communication network so as to obtain a network speaking quality evaluation value, and said network speaking control unit has a display means for displaying said network speaking quality evaluation value obtained.

According to this, the network speaking quality can be understood with a concrete numeric value or grade by the network speaking quality evaluation value. Furthermore, the state of the present speaking quality of the network can be easily recognized by the network speaking quality evaluation value displayed on the display means.

Besides, the present invention is the quality evaluation equipment of network speaking, wherein said network speaking control unit has an outside outputting means for outputting predetermined data outside said network speaking control unit when said network speaking quality evaluation value is below a predetermined value.

According to this, the outside outputting means outputs predetermined data outside the network speaking control unit when the network speaking quality evaluation value is below a predetermined value, thereby an outside network manager can be immediately notified of decline of the speaking quality so that proper measure can be taken.

Besides, the present invention is the quality evaluation equipment of network speaking, wherein said network speaking control unit has a speaking quality evaluation data collection instructing means for instructing to collect said speaking quality evaluation data(for instance, input means, such as a keyboard, a software to be executed in a unit, for outputting a predetermined signal for receiving collection instruction transferred through the communication network and starting collection of the speaking quality evaluation data, and the like), and said network speaking quality judging means starts collecting of said speaking quality evaluation data by an instruction from said speaking quality evaluation data collection instructing means.

According to this, the speaking quality of the network can be grasped at an optional point of time which is necessary, by the speaking quality evaluation data collection instructing means, and a communication business man managing a network can take measures suited to an occasion.

Besides, the present invention is the quality evaluation equipment of network speaking, wherein said speaking quality monitoring unit has an objective tone evaluation computing means for computing an objective tone evaluation value by decoding said voice packet, and said objective tone evaluation computing means is provided with a jitter absorbing means.

According to this, the objective tone evaluation value can be computed and judged, absorbing the fluctuation of the reaching time of the voice packet by the jitter absorbing means, thereby the objective tone evaluation value can be obtained with the voice data corresponding to the actual voice transferred to a speaking receiver by a speaking terminal, and an correct evaluation value can be obtained.

Besides, the present invention is the quality evaluation equipment of network speaking, wherein said jitter absorbing means can adjust a degree of absorbing jitter.

According to this, the jitter absorbing means can adjust the degree of absorbing jitter, thereby the degree of absorbing jitter can be adjusted, fitting to the degree of absorbing jitter of the speaking terminal connected with the speaking quality monitoring unit, and the speaking quality of an individual speaking terminal can be correctly judged.

### BRIEF DESCRIPTION OF THE DRAWINGS

FIG. 1 is a schematic diagram for showing an example of a communication network to which the present invention is applied;

FIG. 2 is a block diagram for showing an example of a speaking quality monitoring unit; and

FIG. 3 is a block diagram for showing an example of a network speaking control unit.

### DESCRIPTION OF THE PREFERRED EMBODIMENTS

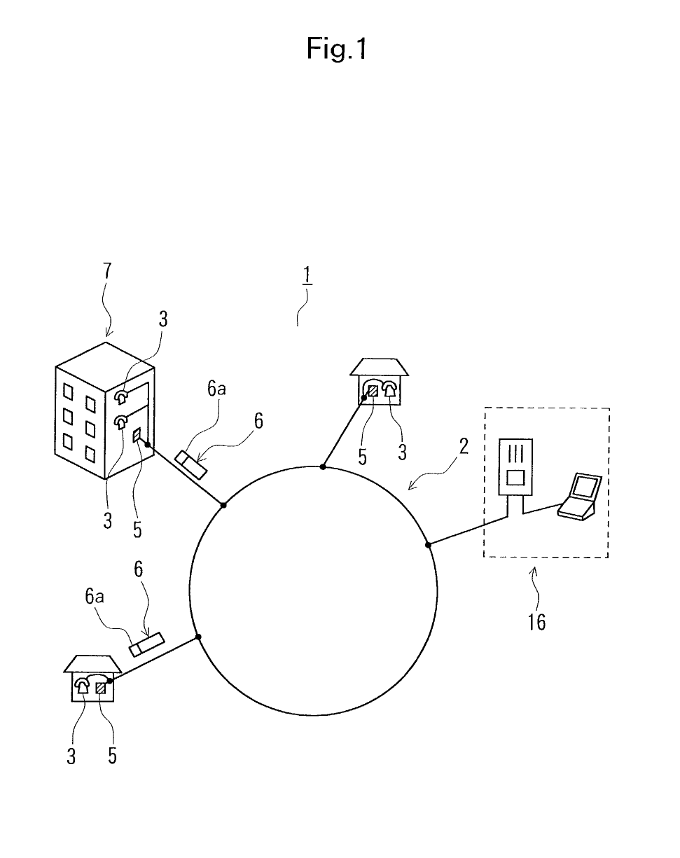

As shown in FIG. 1, a communication network equipment 1 has a communication network 2 through which packet data communication is executed by a communication method, such as the internet protocol. This communication network 2 is a network managed by a specific network manager, which can be used for only a specific member permitted by the network manager, or a public network available for anyone by connecting therewith.

Many speaking terminals 3, each having an IP address, are connected with the communication network 2. A speaking quality monitoring unit 5 comprising a quality evaluation equipment of network speaking according to the present invention is arranged between each speaking terminal 3 and the communication network 2 such that the unit 5 and the speaking terminal 3 are arranged in parallel. The connection form between the speaking quality monitoring unit 5 and each speaking terminal 3 is that one or more speaking terminals 3 are connected with one speaking quality monitoring unit 5, and the speaking quality monitoring unit 5 differentiates a voice telephone speaking from the communication network 2 to each speaking terminal 3 by a well-known destination information 6a including an IP address, attached to a packet (only “a voice packet 6” hereinafter) including voice data, being transmitted from the communication network 2 to each speaking terminal 3.

Then, the speaking quality monitoring unit 5 can easily judge to which speaking terminal 3 each of many voice packets 6 transmitted from the speaking terminal 3 and the communication network 2 is addressed by referring to the IP address attached to the destination information 6a of each voice packet 6 only by providing a single speaking quality monitoring unit 5 even if a building is a multiple dwelling house 7 having many speaking terminals 3.

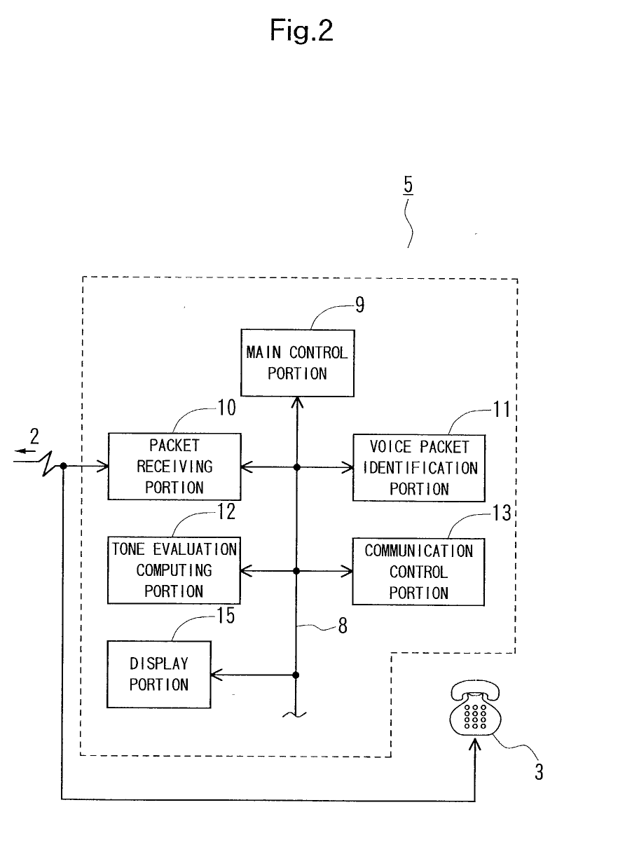

As shown in FIG. 2, the speaking quality monitoring unit 5 has a main control portion 9, and a packet receiving portion 10 connected with the network 2, a voice packet identification portion 11, a tone evaluation computing portion 12, a communication control portion 13, and a display portion 15 are connected with the main control portion 9 through a bus line 8. The speaking terminal 3 is connected with the packet receiving portion in parallel. But, the connection form between the speaking terminal 3 and the speaking quality monitoring unit 5 is not always parallel connection with respect to the network 2 as shown in FIGS. 1 and 2, but both may be connected in series.

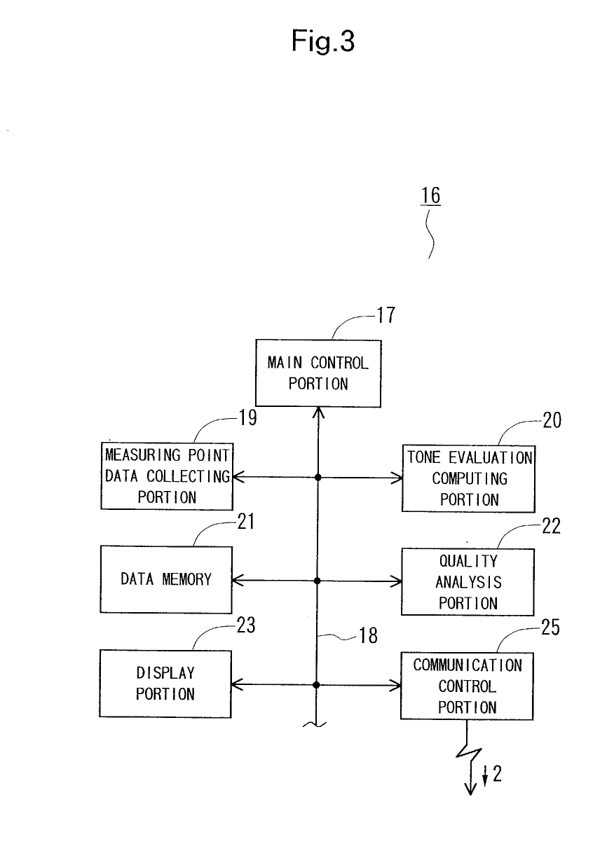

And, a network speaking control unit 16, comprising a quality evaluation equipment of network speaking according to the present invention, is connected with the network 2 together with the speaking quality monitoring unit 5. As shown in FIG. 3, the network speaking control unit 16 has a main control portion 17. With the main control portion 17, a measuring point data collecting portion 19, a tone evaluation computing portion 20, a data memory 21, a quality analysis portion 22, a display portion 23 and a communication control portion 25, connected with the communication network 2, are connected through a bus line 18.

The communication network 2 has the above-mentioned structure. In case of the speaking between the respective speaking terminals 3 connected with the communication network 2, the voice data are transmitted onto the communication network 2 by the speaking terminal 3 on taking side, divided into many voice packets 6. As already explained, the IP address of the speaking terminal 3 of the receiving side, to which voice data is transmitted, is stored in each voice packet 6 as the destination information 6a. And, the speaking quality monitoring unit 5 connected with the network 2 gets the voice packet identification portion 11 to watch the voice packet 6 flowing on the network 2 through the packet receiving portion 10 of FIG. 2, and identifies only voice packet 6 attaching the IP address thereon of the speaking terminal 3 connected with own speaking quality monitoring unit 5 so as to instruct the packet receiving portion 10 to capture. Similarly, each speaking terminal 3 identifies only voice packet addressed to his own out of the voice packets 6 flowing on the communication network 2 so as to capture.

That is, telephone speaking is realized in such a manner that only voice packet 6 corresponding with own IP address is captured at the speaking terminal 3 on the receiving side, and these voice packets 6 are decoded in the inside so as to output as a voice signal. On this occasion, decoding of the voice packet 6 may not executed on the speaking terminal 3 side, but on the speaking quality monitoring unit 5 side. Otherwise, a unit dedicated for decoding may be attached to the speaking terminal 3 so as to use a regular telephone set as the speaking terminal 3.

On this occasion, many voice packets 6 transferred from the speaking terminal 3 of the taking side are received by the speaking terminal 3 of the receiving side via various routes on the network 2, thereby the delay of reaching of the voice packet 6, jitter, disappearance of the voice packet 6 and the like occur. Then, the speaking quality monitoring unit 5 connected with the speaking terminal 3 on the receiving side obtains raw data every speaking quality parameter, such as the delay of the reaching of the voice packet 6, jitter, disappearing of the voice packet 6, delay, reciprocating delay time, objective tone evaluation value concerning the voice packet 6 of the speaking terminal 3 on the receiving side received at the packet receiving portion 10 by a well-known method, and computes and measures the speaking quality evaluation value at that point of time by weighting or referring to a table from the raw data obtained in the tone evaluation computing portion 12, and registers it in the memory (not shown) together with its communicating register. On this occasion, the reciprocating delay time is measured between the speaking terminal 3 of the taking side and the speaking terminal 3 of the receiving side, and the objective tone evaluation value is computed and judged by decoding the voice packet 6.

Besides, it is necessary to voice by restructuring (decoding) voice data from the voice packet in order to evaluate objective tone by the tone evaluation computing portion 12. Since the voice packet has fluctuation (jitter) of reaching time, the processing for absorbing fluctuation in the actual speaking terminal 3 is executed so as to voice. Accordingly, the tone evaluation computing portion 12 is provided with the means for absorbing jitter, and when the quality evaluation value is obtained, the fluctuation of the reaching time is absorbed by the jitter absorbing means and the voice data is decoded so as to evaluate the tone on the basis of the voice data decoded. By doing so, the tone evaluation computing portion 12 can compute objective tone evaluation value, absorbing jitter, that is, on the basis of the voice data corresponding to the voice actually transferred to the receiving person with the speaking terminal 3, and proper evaluation is possible.

There are several methods in order to absorb this fluctuation of the reaching time. For instance, the voice packet is held for a constant time and the processing is executed so as to restructure to such a degree that playing back is possible with original time later, thereby the influence of fluctuation can be softened and absorbed. Besides, it is preferable that the degree of absorbing fluctuation of the reaching time by the jitter absorbing means at the time of computing objective tone evaluation value can be properly adjusted, fitting to the characteristic of the speaking terminal 3.

After the speaking quality evaluation value at the time of speaking concerning the specific speaking terminal 3 connected with the speaking quality monitoring unit 5 is computed at the tone evaluation computing portion 12 in this way, the main control portion 9 displays the speaking quality evaluation value computed on the display portion 15. Various kinds of forms, for instance, evaluation with five stages and a diagram, are thinkable as the display form of this speaking quality evaluation value.

On the other hand, the measuring point data collecting portion 19 of the network speaking control unit 16 communicates with each speaking quality monitoring unit 5 connected with the communication network 2 through the communication network 2 every predetermined time and collects the data of the speaking quality evaluation value concerning the speaking monitored concerning each speaking terminal 3 by its speaking quality monitoring unit 5 as the speaking quality evaluation data so as to store in the data memory 21. And, if necessary or every predetermined time, reciprocating delay time is measured, and the objective tone evaluation value by the tone evaluation computing portion 20 is computed in such a manner that the voice test data owned in advance by the speaking quality monitoring unit 5 and the network speaking control unit 16 are mutually exchanged, between the network speaking control unit 16 and the specific or all speaking quality monitoring units 5 which are connected with the speaking terminal 3. The network speaking control unit 16 stores the result in the data memory 21 as the speaking quality evaluation data.

After the network speaking control unit 16 finishes collecting the speaking quality evaluation value concerning each speaking terminal 3 from all speaking quality monitoring units 5 connected with the communication network 2 at some point of time, the speaking quality of the whole communication network 2 at the point of time is evaluated on the basis of a predetermined evaluation standard by the quality analysis portion 22 from these evaluation values (The speaking quality of a part of the area comprising a plurality of speaking terminals 3 may be evaluated, not always of the whole communication network 2) so as to obtain the network speaking quality evaluation value, and the network speaking quality evaluation value obtained is displayed on the display portion 23. If this network speaking quality evaluation value is lower than a predetermined value and the quality of the voice speaking in the communication network 2 is lower than a predetermined standard, it is displayed on the display portion 23 and a network manager controlling the communication network 2 through the communication control portion 25 is notified of predetermined data, such as with an alarm and a report. These data may be a predetermined alarm signal. Then, the network manager can immediately perceive in which state the speaking quality of the present communication network 2 is.

On this occasion, the speaking quality evaluation data collected by the network speaking control unit 16 are not always the speaking quality evaluation value computed by each speaking quality monitoring unit 5, but may be raw data concerning the speaking quality parameter, such as the delay of reaching of the voice packet 6, jitter, disappearing of the voice packet 6, reciprocating delay time, and objective tone evaluation value, which are the basis for computing the speaking quality evaluation value. Such raw data concerning the speaking quality parameter may collected as the speaking quality evaluation data so as to compute the speaking quality of the network 2 on the network speaking control unit 16 side on the basis of the raw data concerning the speaking quality parameter. By doing so, it is not necessary to provide a large scaled arithmetic unit on the speaking quality monitoring unit 5 side so as to make the speaking quality monitoring unit 5 smaller. In this case, the speaking quality evaluation value on each speaking quality monitoring unit 5 side may be computed so as to notify the speaking quality monitoring unit 5 side, if necessary. In this case, the notified speaking quality evaluation value is displayed on the display portion 15 on the speaking quality monitoring unit 5 side.

Besides, the instruction of evaluating and computing of the speaking quality may be input through a proper input means of the network speaking control unit 16 and the speaking quality evaluating data may be obtained from each speaking quality monitoring unit 5 at an optional time so as to compute the speaking quality concerning the communication network 2.

The present invention is explained on the basis of the embodiment heretofore. The embodiments which are described in the present specification are illustrative and not limiting. The scope of the invention is designated by the accompanying claims and is not restricted by the descriptions of the specific embodiments. Accordingly, all the transformations and changes belonging to the claims are included in the scope of the present invention.

1. Quality evaluation equipment of network speaking for speaking with voice by exchanging voice packets between a plurality of speaking terminals connected with a communication network through said communication network; said equipment comprising:
a speaking quality monitoring unit provided between said communication network and said speaking terminal, capable of obtaining speaking quality evaluation data concerning a voice speaking through said communication network by said speaking terminal;
a network speaking control unit provided on said communication network; and
a network speaking quality judging means provided at said network speaking control unit, for collecting said speaking quality evaluation data computed by a plurality of said speaking quality monitoring units and computing and judging speaking quality of said communication network from said speaking quality evaluation data collected.

2. The quality evaluation equipment of network speaking according to claim 1, wherein said speaking quality evaluation data include at least one data of data of jitter, disappearing, delay, reciprocating delay time, objective tone evaluation value concerning said voice packet obtained by each speaking quality monitoring unit.

3. The quality evaluation equipment of network speaking according to claim 1, wherein said speaking quality monitoring unit comprises a speaking quality evaluation value computing means for judging speaking quality at the time of speaking from said speaking quality evaluation data obtained by said speaking quality monitoring unit and computing as speaking quality evaluation value, and a display means for displaying said speaking quality evaluation value judged by said speaking quality evaluation computing means.

4. The quality evaluation equipment of network speaking according to claim 1, wherein said network speaking quality judging means can compute and judge said speaking quality of said communication network so as to obtain a network speaking quality evaluation value, and said network speaking control unit has a display means for displaying said network speaking quality evaluation value obtained.

5. The quality evaluation equipment of network speaking according to claim 4, wherein said network speaking control unit has an outside outputting means for outputting predetermined data outside said network speaking control unit when said network speaking quality evaluation value is below a predetermined value.

6. The quality evaluation equipment of network speaking according to claim 1, wherein said network speaking control unit has a speaking quality evaluation data collection instructing means for instructing to collect said speaking quality evaluation data, and said network speaking quality judging means starts collecting of said speaking quality evaluation data by an instruction from said speaking quality evaluation data collection instructing means.

7. The quality evaluation equipment of network speaking according to claim 1, wherein said speaking quality monitoring unit has an objective tone evaluation computing means for computing an objective tone evaluation value by decoding said voice packet, and said objective tone evaluation computing means is provided with a jitter absorbing means.

8. The quality evaluation equipment of network speaking according to claim 7, wherein said jitter absorbing means can adjust a degree of absorbing jitter.

9. Quality evaluation equipment of network speaking for speaking with voice by exchanging voice packets between a plurality of speaking terminals connected with a communication network through said communication network; said equipment comprising:
a speaking quality monitoring unit provided between said communication network and said speaking terminal, capable of obtaining speaking quality evaluation data concerning a voice speaking through said communication network by said speaking terminal;
a network speaking control unit provided on said communication network; and
a network speaking quality judging unit provided at said network speaking control unit, for collecting said speaking quality evaluation data computed by a plurality of said speaking quality monitoring units and computing and judging speaking quality of said communication network from said speaking quality evaluation data collected.

10. The quality evaluation equipment of network speaking according to claim 9, wherein said speaking quality monitoring unit comprises a speaking quality evaluation value computing unit for judging speaking quality at the time of speaking from said speaking quality evaluation data obtained by said speaking quality monitoring unit and computing as speaking quality evaluation value and a display unit for displaying said speaking quality evaluation value judged by said speaking quality evaluation computing unit.

11. The quality evaluation equipment of network speaking according to claim 9, wherein said network speaking quality judging unit can compute and judge said speaking quality of said communication network so as to obtain a network speaking quality evaluation value, and said network speaking control unit has a display unit for displaying said network speaking quality evaluation value obtained.

12. The quality evaluation equipment of network speaking according to claim 11, wherein said network speaking control unit has an outside outputting unit for outputting predetermined data outside said network speaking control unit when said network speaking quality evaluation value is below a predetermined value.

13. The quality evaluation equipment of network speaking according to claim 9, wherein said network speaking control unit has a speaking quality evaluation data collection instructing unit for instructing to collect said speaking quality evaluation data, and said network speaking quality judging unit starts collecting of said speaking quality evaluation data by an instruction from said speaking quality evaluation data collection instructing unit.

14. The quality evaluation equipment of network speaking according to claim 9, wherein said speaking quality monitoring unit has an objective tone evaluation computing unit for computing an objective tone evaluation value by decoding said voice packet, and said objection tone evaluation computing unit is provided with a jitter absorbing unit.

15. The quality evaluation equipment of network speaking according to claim 14, wherein said jitter absorbing unit can adjust a degree of absorbing jitter.
